(19) United States
(12) Patent Application Publication
(10) Pub. No.: US 2008/0258874 A1
(43) Pub. Date: Oct. 23, 2008

(54) TRANSPONDER CIRCUIT ARRANGEMENT AND METHOD FOR OPERATING A DEMODULATOR

(75) Inventors: Gerald HOLWEG, Graz (AT); Christian KLAPF, Bad Hofgastein (AT); Walter KARGL, Graz (AT); Albert MISSONI, Graz (AT); Guenter HOFER, St. Oswald (AT)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies Austria AG, Villach (AT)

(21) Appl. No.: 12/104,477

(22) Filed: Apr. 17, 2008

(30) Foreign Application Priority Data
Apr. 17, 2007 (DE) 10 2007 018097.9

(51) Int. Cl. H04Q 5/22

(52) U.S. Cl. 340/10.1

(57) ABSTRACT

A transponder circuit arrangement including antenna contacts to which an antenna signal can be applied. The antenna signal includes at least one signal in one transmission band of a plurality of transmission bands. The transponder circuit arrangement also includes a detector adapted to detect whether the antenna signal includes a signal in a predetermined transmission band, and a demodulator adapted to demodulate the signal in the predetermined transmission band when the signal has been detected therein, and otherwise to demodulate a signal in another transmission band.

### CROSS-REFERENCE TO RELATED APPLICATION

This application claims priority to German Patent Application Serial No. 102007018097.9, which was filed Apr. 17, 2007, and is incorporated herein by reference in its entirety.

### FIELD OF THE INVENTION

The invention relates to a transponder circuit arrangement and to a method for operating a demodulator.

### BACKGROUND

So-called radio frequency identification systems, RFID systems for short, are becoming more and more widely used. In principle, they comprise two components, namely a so-called transponder and an acquisition device which is usually a combined read/write device.

The transponder can be attached to an object which is provided for identification, the acquisition device performing this identification contactlessly. The acquisition device typically comprises a module with transmitter, receiver, a control device and a coupling element to the transponder. The transponder, which represents the actual data carrier of an RFID system, usually comprises a coupling element and an electronic component, for example a so-called chip. Usually, no separate voltage supply is provided in the transponder. Outside the response range of the acquisition device, it behaves passively. Energy needed to operate the transponder is transmitted contactlessly to the transponder by the coupling unit.

Communication between the transponder and the acquisition device usually takes place by means of a modulated data signal.

The frequency ranges used for communication in RFID systems vary in dependence on the requirements. High-frequency or low-frequency frequency ranges can be used for communication. For example, the transmissible power, the range, the influence of the transmitted signal on various materials of the circuit arrangement and the data rate are dependent on the frequency range used.

RFID transponders with an antenna which is selective for a number of frequencies allow the field of application of RFID systems to be expanded since it is possible to transmit data in two frequency ranges. The corresponding chips with integrated circuit arrangement of such transponders may comprise two mutually separate receiving devices and two demodulators.

### BRIEF DESCRIPTION OF THE DRAWINGS

Embodiments are explained with reference to the drawing, in which:

FIG. 1 shows an embodiment of a transponder circuit arrangement.

FIG. 2 shows an embodiment of a transponder circuit arrangement at which an antenna signal is present.

FIG. 3 shows the embodiment of the transponder circuit arrangement at which another antenna signal is present.

FIG. 4 shows a further embodiment of a transponder circuit arrangement.

FIG. 5 shows an embodiment of a method for operating a demodulator.

FIG. 6 shows a further embodiment of a method for operating a demodulator.

### DETAILED DESCRIPTION

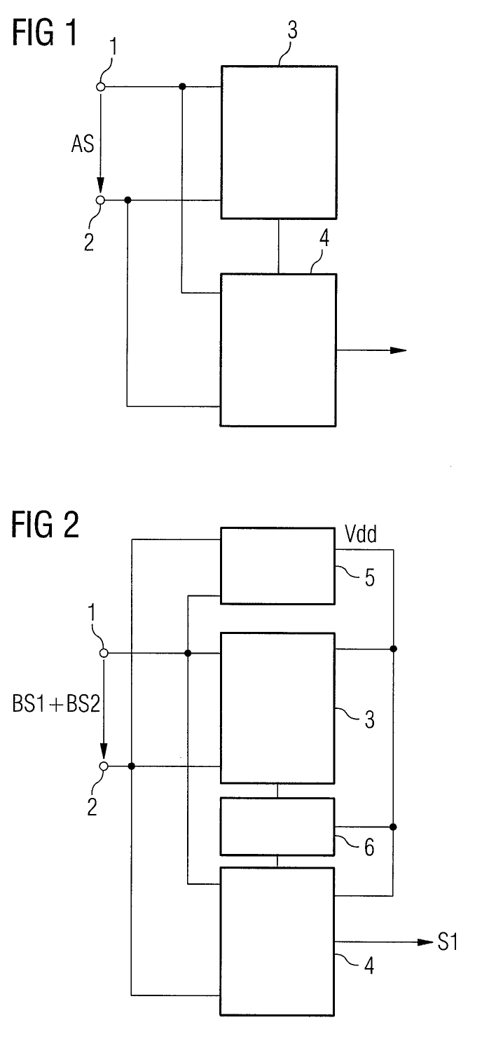

FIG. 1 shows an embodiment of a transponder circuit arrangement with antenna contacts 1, 2 to which an antenna signal AS can be applied. The antenna signal AS comprises at least one signal in one transmission band from a plurality of transmission bands. Furthermore, a detector 3 is provided which is arranged for detecting whether the antenna signal AS comprises a signal in a predetermined transmission band. Furthermore, a demodulator 4 is provided which is arranged for demodulating the signal in the predetermined transmission band when the signal has been detected therein, and otherwise for demodulating a signal in another transmission band.

Such an analog front end of a transponder can be operated in various transmission bands. In one embodiment, the transponder circuit arrangement is provided in integrated form in a chip. A single antenna by means of which the transmission in various transmission bands is possible can be connected to the antenna contacts. The transponder circuit arrangement components are selectively designed for a number of frequencies in order to provide for operation in the various transmission bands.

By providing two antenna contacts for a broadband antenna and only one receiving device coupled thereto, with detector and a demodulator for demodulating in various transmission bands, the size of the transponder circuit is reduced in comparison with conventional transponder circuits. The circuit area is less particularly in the case of integrated embodiment which is also associated with cost savings in the production. Although an antenna signal can comprise signals in a number of transmission bands, only the signal in one is demodulated. The selection is made by means of a predetermined order of rank of the transmission bands. In one embodiment, the other signals received are suppressed.

In one embodiment, a selection circuit is provided for setting the transmission band in which a demodulator demodulates a signal.

The transmission band in which demodulation takes place is selected in accordance with a predetermined order of rank of transmission bands. If signals are present in a number of transmission bands, the signal in the transmission band having the highest rank is demodulated.

FIG. 2 shows a further embodiment of a transponder circuit arrangement. This transponder circuit arrangement comprises antenna contacts 1, 2, a detector 3, a demodulator 4, a selection device 6 and a supply device 5 in order to provide a supply voltage Vdd. The antenna contacts 1, 2 are coupled both to the detector 3 and to the demodulator 4 and to the supply device 5. Between the detector 3 and the demodulator 4, the selection device 6 is coupled in order to set the transmission band in which the demodulator 4 demodulates a signal.

In the present embodiment, an antenna signal BS1+BS2 is applied to the antenna contacts 1, 2, for example, which comprises a first signal BS1 in a first transmission band and a second signal BS2 in a second transmission band. The detector 3 detects whether the antenna signal present comprises a signal in a predetermined transmission band which is the first transmission band in the present embodiment. The demodulator 4 demodulates the first signal BS1 which is in the predetermined first transmission band, and outputs a demodulated signal S1. It should be noted that the antenna signal can comprise a number of signals in various transmission bands. One of these signals is such that it can be detected in the corresponding transmission band. In an embodiment, a signal has a band-pass characteristic, the frequency components of which are concentrated in one of the transmission bands so that this can also be called a band-pass signal. In one embodiment, the signal can comprise a sinusoidal signal.

The transmission band is set by means of the selection device 6. In one embodiment, the demodulator 4 is preset in such a manner that the first signal BS1 in the first transmission band is demodulated. The selection device only switches the demodulator if the first signal BS1 has not been detected. It is provided to demodulate either the first signal BS1 in the first transmission band when it has been detected or the second signal BS2 in the second transmission band. To demodulate in two different transmission bands, it may be sufficient that the selection device 6 provides a switching signal so that the demodulator 4 preset to the first transmission band demodulates the second signal BS2 in the second transmission band.

In one embodiment, the predetermined transmission band is a UHF band and the other transmission band is an HF band. In another embodiment, the predetermined transmission band is an HF band and the other transmission band is a UHF band.

In the operation of an embodiment which prioritizes the HF band, the circuit arrangement, after detection of the signal in the HF band, is set in such a manner that the HF band is selected for communication, the circuit waits for the communication of an acquisition device, if appropriate, and all other frequency bands are suppressed.

The supply device 5 feeds the transponder circuit arrangement with the supply voltage Vdd as soon as an antenna signal AS is present. It should be noted that feeding occurs independently of the transmission band in which the signal to be demodulated is located. The supply device 5 is designed to be a wide band device so that it provides the supply voltage Vdd for the transponder circuit arrangement and its components, among others the detector 3, the selection device 6 and the demodulator 4, independently of the antenna signal present and the signals comprising it.

In one embodiment, an operating range of the supply device 5 can be set in order to provide for better adaptation of the supply device 5 to the antenna signal, for example by setting the operating range in dependence on the transmission band in which the signals are located.

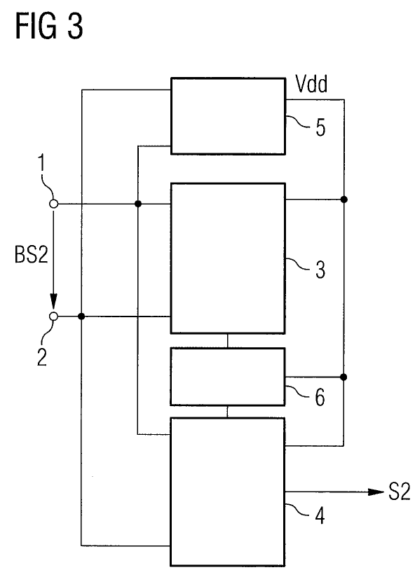

FIG. 3 shows the embodiment from FIG. 2. But now the second signal BS2 is present as antenna signal at the antenna contacts 1, 2.

The detector 3 detects that the antenna signal does not comprise the first signal BS1 in the predetermined first transmission band. In consequence, the selection device 6 switches the demodulator 4 in such a manner that the second signal BS2 in the second transmission band is demodulated. A second signal S2 is provided at the output of the demodulator 4.

In one embodiment, the detector 3 detects from a plurality of transmission bands, the order of rank of which is predetermined, the transmission band with the highest rank in which a signal is present. In one embodiment, the detection is performed in such a manner that the detector 3 detects the transmission bands in a predetermined order of rank with regard to a signal located therein. In this context, the transmission bands are detected successively until a signal has been detected. The selection circuit sets the transmission band in which the detected signal is present. This is the transmission band with the highest order of rank in which a signal is present.

In one embodiment, the detector 3 comprises a storage device for storing the order of rank of the transmission bands. For the same purpose, a state machine is provided in a further embodiment.

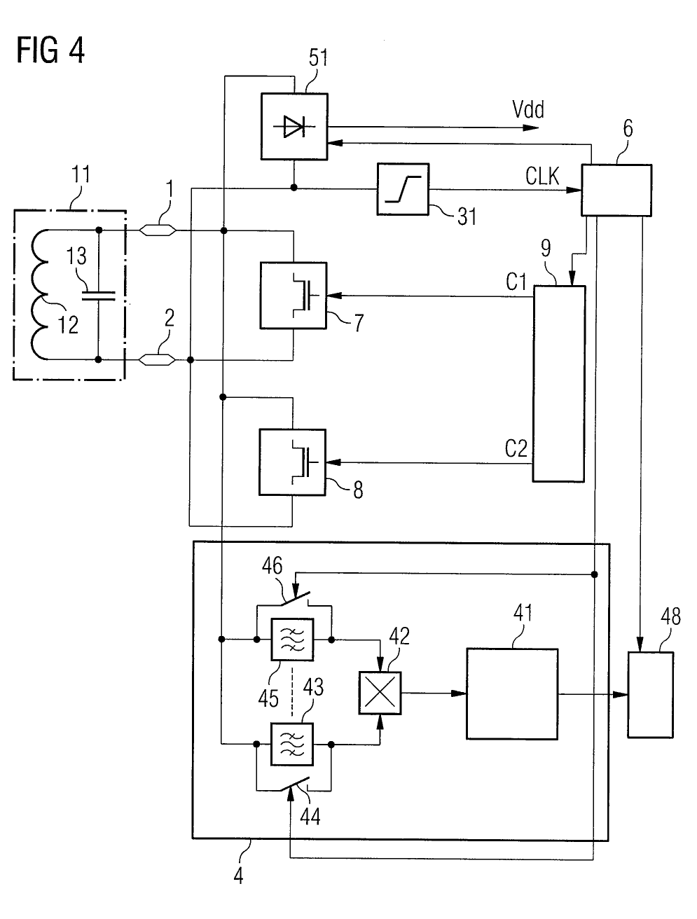

FIG. 4 shows in detail an embodiment of a transponder with a transponder circuit arrangement and an antenna 11. This comprises an inductive coupling element 12. The capacitance of the antenna 11 is illustrated by the capacitor 13. The antenna 11 is coupled to the antenna terminals 1, 2.

Furthermore, a rectifier 51, a shunt 7, a modulation device 8 and a demodulator 4 which is followed by a decoder 48 are provided in the transponder circuit arrangement. These are coupled to the antenna terminals 1, 2.

The rectifier 51 provides the supply voltage Vdd as soon as an antenna signal is present. In one embodiment, a wide-band rectifier is provided which comprises a charge pump.

A part of the current induced in the antenna 11 which is not required for operating the transponder circuit arrangement flows off via the shunt 1. The shunt 7 can be set with regard to the antenna voltage by a control signal C1.

The modulation device 8 is arranged as a wide band device so that it can be operated in different transmission bands. In one embodiment, the depth of modulation can be set via a control signal C2.

The control signals C1 and C2 are provided by a digital section 9 of the circuit arrangement, in which the data processing also takes place.

The detector used is a clock recovery device 31 by means of which the transmission band is detected in which the signal to be demodulated is located. The clock recovery device 31 is arranged for generating a clock signal CLK in a predetermined transmission band. If a signal is located in the predetermined transmission band, the clock signal CLK can be generated from the signal. If the clock signal CLK cannot be generated, the clock recovery is carried out with regard to another frequency or a clock signal internal to the circuit is generated. The clock recovery device 31 is followed by a selection device 6 which sets the demodulator 4 with regard to the transmission band in which demodulation is to be performed.

In one embodiment, the clock recovery device 31 is arranged for generating a clock signal CLK in the HF band when a corresponding signal is transmitted. The demodulator 4 is preset in such a manner that it demodulates in the HF band when a clock signal CLK can be generated by the clock recovery device 31. If this is not possible, demodulation occurs in the UHF band. In another embodiment, the clock recovery is carried out in the UHF band.

In one embodiment, a peak-value detector is provided which picks up the signal at the input end of the demodulator 4 or is coupled between selective filters and the demodulator 4. By means of the selective filters, a transmission band with the highest rank is selected and signals in other transmission bands are suppressed. The circuit arrangement is operated in the selected transmission band.

An embodiment of the modulator 4 comprises a baseband demodulator 41, a mixer 42, and a first and a second band-pass filter 43, 45 which can be bypassed via first and second switches 44, 46. The signal present at the input end of the demodulator 4 can be supplied to the mixer 42 via a first branch with the first band-pass filter 43 and the first switch 44 and via a second parallel branch with the second band-pass filter 45 and the second switch 46.

The band-pass filters 43 and 45 are used for selecting the transmission band. The first band-pass filter 43 filters a first signal in the HF band. The second band-pass filter 45 filters a second signal in the UHF band. The selection of one of the band-pass filters 43, 45 is effected via the selection device 4. When a clock signal CLK is generated which is present at the selection device 4, the first signal is filtered out of the signal present and is supplied to the mixer 42 via the first branch. The other branch is deactivated. If no clock signal CLK can be generated, the second signal is filtered and supplied to the mixer 42 via the second branch. The other branch is deactivated. It is also possible, with closed switches 44 and 46, respectively, when a clock signal CLK can be generated, to supply the signal unfiltered to the mixer 42 via the first branch, and if no clock signal CLK can be generated, to supply the signal to the mixer 42 unfiltered and via the second branch.

The mixer 42 down-converts the signal present. After that, it is demodulated by a downstream baseband demodulator 41.

The demodulated signal is supplied to the decoder 48 for decoding. The decoder 48 follows the baseband demodulator 41. The decoded data can be processed internally in the circuit.

In the embodiment shown it is provided that the selection device 6, apart from the demodulator 4, also switches the digital section 9 and the decoder 48 and the rectifier 51 in such a manner that their operation is adapted to the signal to be demodulated. This comprises, for example, the setting of the operating point, the decoding method used in the decoder 48 or the setting of the modulation device 8 and of the shunt 7 by the corresponding control signals C2 and C1, respectively. In one embodiment, the components are coupled directly to the selection device 6 which provides corresponding signals for switching as illustrated, by way of example, by means of rectifier 51 and of decoder 48. In one embodiment, the selection device 6 switches the digital section 9, which adapts the operation of the components via corresponding control signals C1, C2, as illustrated by means of the shunt 7 and the modulation device 8 by way of example.

Suitable transmission bands in which the transmission can take place are, for example, the LF band, with a frequency in the range from 100 to 135 kHz, and the HF band with a frequency around 13.56 MHz. In both cases, the data are transmitted via inductive coupling. Furthermore, the UHF band with a frequency in the range of 886 or 915 MHz, respectively, and the MWF band with a frequency in the range of 245 GHz are suitable. In the two cases mentioned last, transmission takes place by electromagnetic coupling. In further embodiments, other transmission bands are used.

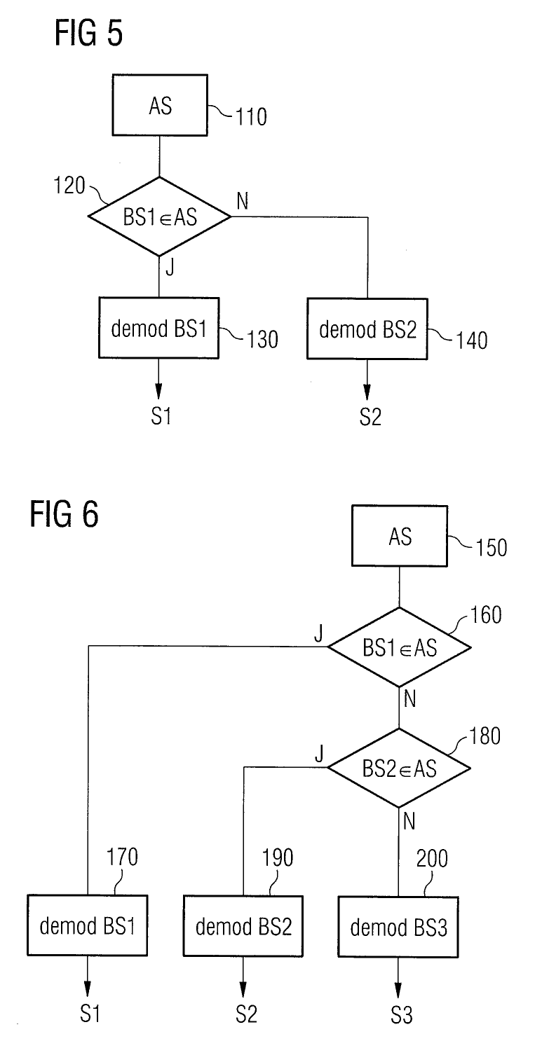

FIG. 5 illustrates a method for operating a demodulator by means of an embodiment.

The embodiment in FIG. 5 relates to antenna signals AS which comprise a first signal BS1 and/or a second signal BS2.

The method provides for providing an antenna signal AS which comprises a signal BS1 in one transmission band from a plurality of transmission bands. This is illustrated by block 110.

Block 120 illustrates that it is detected whether the antenna signal AS comprises a signal BS1 in a predetermined transmission band. If the signal BS1 has been detected in the predetermined transmission band, the signal BS1 is demodulated which is illustrated by block 130. Otherwise, a signal BS2 in another transmission band is demodulated which is illustrated by block 140.

In the first-mentioned case, a demodulated signal S1 is provided and in the other case, a demodulated signal S2 is provided.

FIG. 6 shows a further embodiment of a method which illustrates the procedure for more than two demodulatable signals.

An antenna signal AS is provided as is illustrated by block 150. Then it is detected whether the antenna signal AS comprises a first signal BS1 in a predetermined first transmission band. This is illustrated by block 160.

If this is the case, the first signal BS1 in the first transmission band is demodulated and a first demodulated signal S1 is provided which is illustrated by block 170.

If the antenna signal AS does not comprise a first signal BS1 in a predetermined first transmission band, it is detected whether the antenna signal AS comprises a second signal BS2 in a predetermined second transmission band.

If this is the case, the second signal BS2 is demodulated and the second demodulated signal S2 is provided which is illustrated by block 190.

If the antenna signal AS does not comprise a second signal BS2 in a predetermined second transmission band, a third signal is demodulated and a third demodulated signal S3 is provided as is illustrated by block 200.

In an alternative embodiment, a detection step is provided before the demodulation of the third signal BS3 in order to check whether the antenna signal AS comprises the third signal BS3.

In another embodiment, this multi-stage procedure for detecting the transmission band with the highest ranking in which a signal is located is extended correspondingly to more than three transmission bands.

1. A transponder circuit arrangement comprising:
antenna contacts to which an antenna signal, which comprises at least one signal in one transmission band of a plurality of transmission bands, can be applied;
a detector adapted to detect whether the antenna signal comprises a signal in a predetermined transmission band; and
a demodulator adapted to demodulate the signal in the predetermined transmission band if the signal has been detected in the predetermined transmission band, and otherwise to demodulate a signal in another transmission band.

2. The transponder circuit arrangement as claimed in claim 1, further comprising a selection device adapted to set the transmission band in which the demodulator demodulates a signal.

3. The transponder circuit arrangement as claimed in claim 1, wherein the detector is further adapted to detect from a plurality of transmission bands, which has a predetermined order of rank, the transmission band with the highest order of rank in which a signal is located.

4. The transponder circuit arrangement as claimed in claim 3, wherein the detector is further adapted to detect the transmission bands in the predetermined order of rank until a signal is detected in at least one of the transmission bands.

5. The transponder circuit arrangement as claimed in claim 3, further comprising a selection device, adapted to set the transmission band with the highest rank in which a signal is located, as transmission band in which the demodulator demodulates.

6. The transponder circuit arrangement as claimed in claim 1, further comprising a supply device adapted to feed the transponder circuit arrangement.

7. The transponder circuit arrangement as claimed in claim 6, wherein an operating range of the supply device can be set.

8. The transponder circuit arrangement as claimed in claim 2, wherein the selection device is further adapted to switch the operation of a digital section of the transponder circuit arrangement.

9. The transponder circuit arrangement as claimed in claim 1, wherein the plurality of transmission bands comprise a UHF band and an HF band.

10. The transponder circuit arrangement as claimed in claim 1, wherein the detector comprises a storage device.

11. The transponder circuit arrangement as claimed in claim 1, wherein the detector comprises a state engine.

12. A transponder circuit arrangement comprising:
antenna contacts to which an antenna signal, which comprises at least one signal in one transmission band of a plurality of transmission bands, can be applied;
a detector adapted to detect from a group of transmission bands, which has a predetermined order of rank, the transmission band with the highest rank in which a signal is located;
a demodulator, adapted to demodulate the signal in the transmission band having the highest rank of the order of rank if a signal has been detected in the transmission band having the highest rank of the order of rank and otherwise to demodulate a signal in another transmission band; and
a selection device, which is coupled to the detector and the demodulator, and which is adapted to set the transmission band with the highest rank in which a signal is located, so that the demodulator demodulates the signal in that transmission band.

13. The transponder circuit arrangement as claimed in claim 12, further comprising a supply device adapted to feed the transponder circuit arrangement when an antenna signal is present, wherein the transponder circuit arrangement is adapted to feed independently of the signal which is comprised in the antenna signal or to feed independently of the signals which are comprised in the antenna signal.

14. The transponder circuit arrangement as claimed in claim 12, further comprising a decoder which follows the demodulator and can be switched.

15. The transponder circuit arrangement as claimed in claim 12, further comprising an antenna which is coupled to the antenna contacts, wherein the antenna can be operated in the predetermined transmission band and in the other transmission band.

16. A method for operating a demodulator, comprising:
providing an antenna signal which comprises at least one signal in one transmission band of a plurality of transmission bands;
detecting whether the antenna signal comprises a signal in a predetermined transmission band; and
demodulating the signal if the signal has been detected in the predetermined transmission band, and otherwise demodulating a signal in another transmission band.

17. The method as claimed in claim 16, wherein, from a plurality of transmission bands, which has a predetermined order of rank, the transmission band with the highest rank is detected in which a signal is located.

18. The method as claimed in claim 16, wherein the transmission bands are detected in the predetermined order of rank with regard to a signal until a signal has been detected in at least one of the transmission bands.

19. The method as claimed in claim 16, wherein the demodulation occurs in the transmission band with the highest rank in which a signal is located.

20. The method as claimed in claim 16, further comprising:
providing a supply voltage, which is converted from the antenna signal, for operating the demodulator.

21. The method as claimed in claim 20, wherein the supply voltage is provided independently of the signal which is comprised in the antenna signal or independently of the signals which are comprised in the antenna signal.

22. The method as claimed in claim 16, wherein the predetermined transmission band is an HF band and the other transmission band is a UHF band.

23. The method as claimed in claim 16, wherein the predetermined transmission band is a UHF band and the other transmission band is an HF band.

24. A transponder circuit arrangement comprising:
means for applying an antenna signal which comprises at least one signal in one transmission band of a plurality of transmission bands;
means for detecting whether the antenna signal comprises a signal in a predetermined transmission band; and
means for demodulating the signal when the signal has been detected in the predetermined transmission band, and otherwise demodulating a signal in another transmission band.
